(19) United States
(12) Patent Application Publication
(10) Pub. No.: US 2017/0009394 A1
(43) Pub. Date: Jan. 12, 2017

(54) LAUNDRY HOLDER WITH SNARE AND IMPROVEMENTS THEREFOR

(71) Applicant: Laundry Loops, Inc., Bozeman, MT (US)

(72) Inventors: Peggy R. Durney, Bozeman, MT (US); Michael J. Durney, Bozeman, MT (US)

(21) Appl. No.: 15/202,438

(22) Filed: Jul. 5, 2016

Related U.S. Application Data
(60) Provisional application No. 62/189,136, filed on Jul. 6, 2015.

(51) Int. Cl. D06F 95/00; G09F 3/16; G09F 3/14; A44B 11/25; A44B 19/26

(52) U.S. Cl. CPC D06F 95/008; A44B 11/25; A44B 19/262; G09F 3/14; G09F 3/16; G09F 2003/0282

(57) ABSTRACT

A laundry holding device for keeping specified laundry items separable during washing and drying is provided. The laundry device can include an elongated strap with connecting means provided on each end for securing the strap in an enclosed loop. The strap can be inserted through laundry items having full openings and then enclosed by the connecting means to retain the items on the laundry device for laundering. The laundry device can include an identification label attached to the outer side of the strap. The label can be attached by folding each end and sewing each folded end to the strap to prevent frayed or damaged edges. The laundry device can include a garment snare attached to the strap for holding laundry items without full openings. The snare can include a cord pair with end and intermediate stoppers and a fastener between the stoppers for securing laundry items.

### CROSS-REFERENCE TO RELATED APPLICATIONS

This Application claims priority to U.S. Provisional Patent Application Ser. No. 62/189,136, filed on Jul. 6, 2015, to Peggy R. Durney et al., entitled “Laundry Holder with Snare and Improvements Therefor,” currently pending, the entire disclosure of which is incorporated herein by reference.

### FIELD OF THE INVENTION

The present invention relates to a device for holding laundry and keeping the laundry separate when laundered in a larger set of laundry, and in particular a device for holding a single individual's laundry, including shirts, shorts, pants, socks and the like, when laundering the single individual's clothing at home and/or when several individuals' clothing is laundered together in single loads.

### BACKGROUND OF THE INVENTION

There are commonly situations where multiple individuals' laundry needs to be laundered together in a single load. In such situations, it is necessary to keep each individual's laundry separated from the other individuals' laundry. Similarly, there are situations where an individual desires to keep certain laundered items separated yet still washed together in a single load of laundry. Several different devices have been used to accomplish this goal, each having its own limitations and deficiencies. One such device, disclosed in U.S. Pat. No. 6,038,748 to Peggy R. Durney and Michael J. Durney, the entire disclosure of which is herein incorporated by reference, is a laundry holder that may form a loop by use of a buckle. The present invention is directed toward improvements on such a laundry device.

### SUMMARY OF THE INVENTION

The present invention is directed generally to an improved laundry holder. The laundry holder includes a strap or band and fastening means attached to each end of the strap. The fastening means can be in the form of releasable buckle components according to one embodiment of the present invention. The fastening means allows the strap to be selectively secured with its ends together in order to form an enclosed loop or ring. As a result, the laundry holder can be configured to hold and secure together one or more items of clothing or garments while such items of clothing are laundered. In order to use the laundry holder, the ends of the strap are unfastened and one end is inserted through openings in each item of clothing to be laundered. After each desired item of clothing has been placed on the laundry holder, the ends of the strap are then fastened together to form the enclosed loop or ring. The laundry holder can then be combined with other garments to be laundered and/or other laundry holders to be collectively washed and dried. After completion of the laundering cycle, the laundry holder can be easily separated from the other garments and/or laundry holders, thereby keeping the individual's laundry separated.

Connected to the strap of the laundry holder can be an improved identification (ID) label to allow for easy identification of a specific user's laundry holder when it is laundered with other user's laundry holders. The label can have a first end and second end secured to the surface of the strap according to one embodiment of the present invention. Each end can be specially configured to have a lower folded region and an upper folded region secured to the surface of the strap. As a result, a portion of each end is essentially folded onto itself to create a folded end. This configuration can provide for better securement to the strap and reduce the existence of frayed edges and subsequent detachment of the label after prolonged usage. The ID label can also have a central divider region, which can be in the foam of a connecting seam that can divide the label into first and second regions. This segmented configuration of the label can allow manufacturer information to be placed separate from the user information and allow the user information to be positioned adjacent the fastening means making it easier to find the user identification information. This configuration also minimizes the potential for the label being unintentionally separated or ripped-off of the strap and for garments becoming wedged between the label and the strap.

Also connected to the laundry holder can be one or more garment snares for holding socks and similar items without continuous openings. Each garment snare can be constructed from two cord segments positioned together and secured at one end to the strap. The snare can further include an end stopper, such as a knot, placed at the free end of the cord segments in order to create a loading region or opening between the two cords. The snare can also include one or more intermediate stoppers positioned along the length of the snare in order to create multiple loading regions. Within each loading region can be a slidable clasp, such as a cordlock fastener. In another embodiment, the garment snare can be constructed as a clamp or clip which can have serrated notches or teeth, such as a jaw or alligator clamp, that hold the garments in place when the clamp is secured in a closed position. The garment snare can be used by inserting garments, such as a sock, into the loading region or opening defined between the cord segments and then sliding the cordlock until the garments in the loading region are snuggly secured between the cordlock and a stopper.

Other aspects and advantages of the present invention will be apparent from the following detailed description of the preferred embodiments and the accompanying drawings figures.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a top perspective view of an improved laundry holder in an enclosed configuration in accordance with one embodiment of the present invention;

FIG. 2 is a top perspective view of the laundry holder of FIG. 1 illustrating the laundry holder in an unfastened position;

FIG. 3 is a front view of an improved laundry holder in accordance with one embodiment of the present invention;

FIG. 4 is a top view of an improved laundry holder in accordance with one embodiment of the present invention;

FIG. 5 is a top view of a first end of the improved laundry holder of FIG. 1;

FIG. 6 is a top view of a second end of the improved laundry holder of FIG. 1;

FIG. 7 is a side view of an ID label connected to an improved laundry holder in accordance with one embodiment of the present invention;

FIG. 8A is a partial top view the ID label and improved laundry holder of FIG. 7 illustrating the attachment of a first end of the ID label to a strap of the improved laundry holder in accordance with one embodiment of the present invention;

FIG. 8B is a partial top view the ID label and improved laundry holder of FIG. 7 illustrating the attachment of a second end of the ID label to a strap of the improved laundry holder in accordance with one embodiment of the present invention;

FIG. 9 is a top perspective view of a garment snare for use in an improved laundry holder in accordance with one embodiment of the present invention;

FIG. 10 is a top perspective view of a garment snare for use in an improved laundry holder in accordance with one embodiment of the present invention;

FIG. 11 is a perspective view of an improved laundry holder having multiple garment snares in accordance with an alternative embodiment of the present invention; and

FIG. 12 is a perspective view of an improved laundry holder being loaded with laundry garments in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

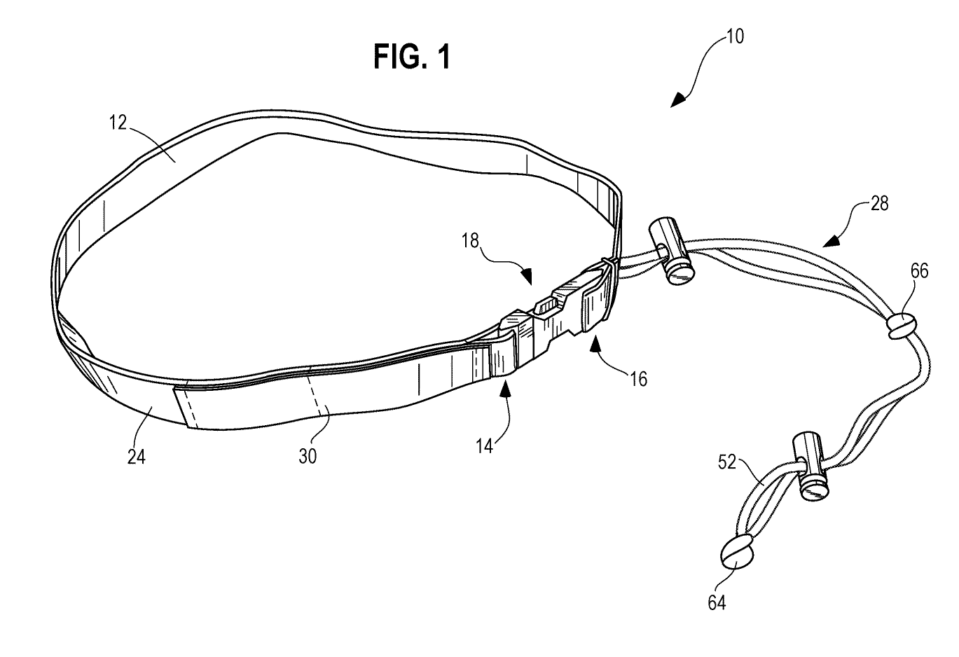

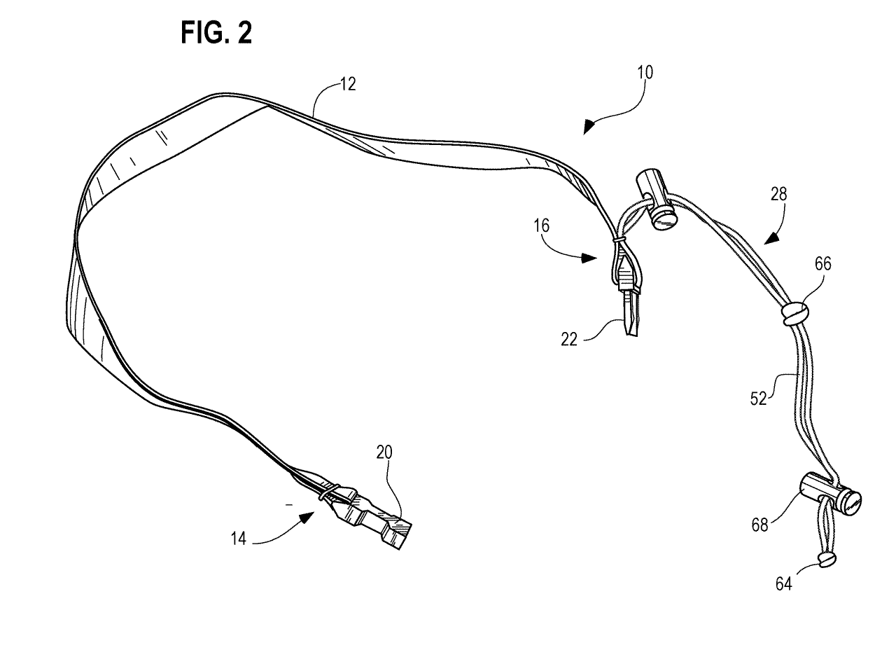

The present invention is generally directed to an improved laundry holder device 10, as shown in FIGS. 1 and 2. Laundry holder 10 can include an elongate strap 12 that can have a first end 14 and a second 16 as best shown in FIG. 2. Elongate strap 12 can comprise a webbing and be constructed from any material suitable for prolonged use in conjunction with washing and drying cycles. According to one embodiment of the present invention, elongate strap 12 is constructed from a polypropylene webbing. Elongate strap 12 can also be constructed from several other suitable materials, including but not limited to nylon, treated fabric, plastic, rubber-based or poly-base materials.

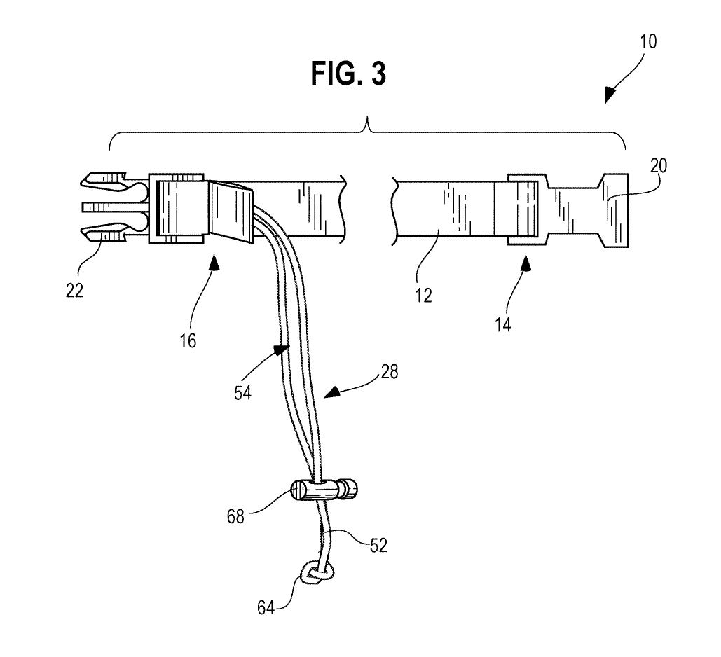

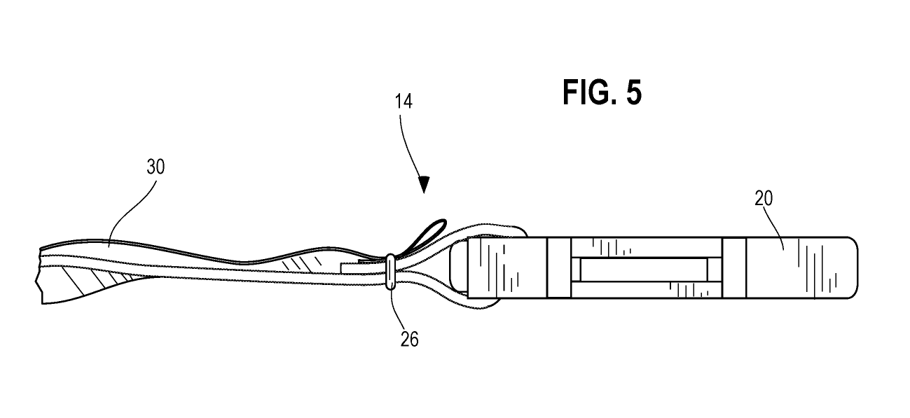

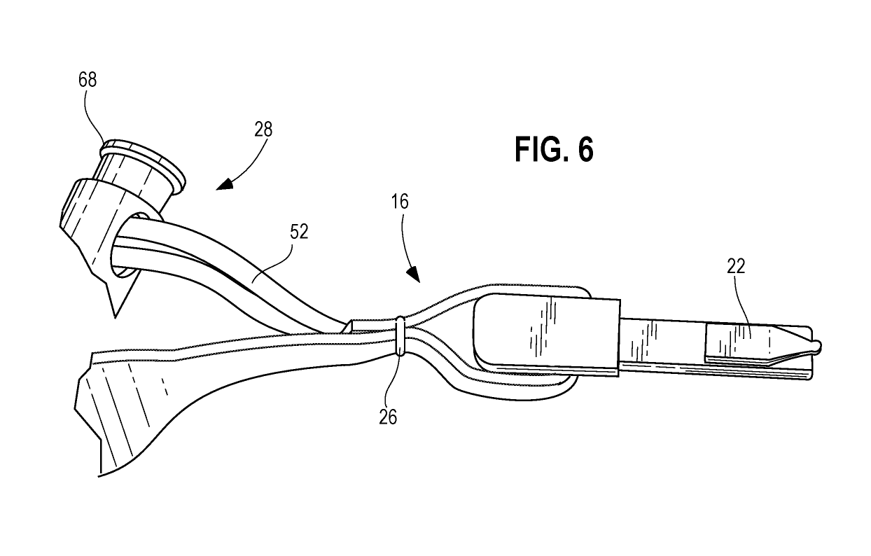

First and second ends 14 and 16 of strap 12 can be configured to be secured together by a fastener or alternative securing means 18, as illustrated in FIG. 1, so that elongate strap 12 forms an enclosed loop shape. Fastener or securing means 18 can be configured to allow ends 14 and 16 to be selectively removable so that elongate strap 12 can be opened as shown in FIG. 2 and closed as shown in FIG. 1. Fastener 18 can comprise a conventional side-squeeze buckle as shown in FIG. 3 according to one embodiment of the present invention. According to another embodiment, fastener 18 can comprise a buckle constructed from Delrin® or similar ACETAL compound, as shown in FIGS. 5 and 6, which can have a lower absorption rate and provide for a longer effective lifespan of the fastener 18 when used in many washing and drying cycles. Several alternative fastening means can also be used for fastener 18.

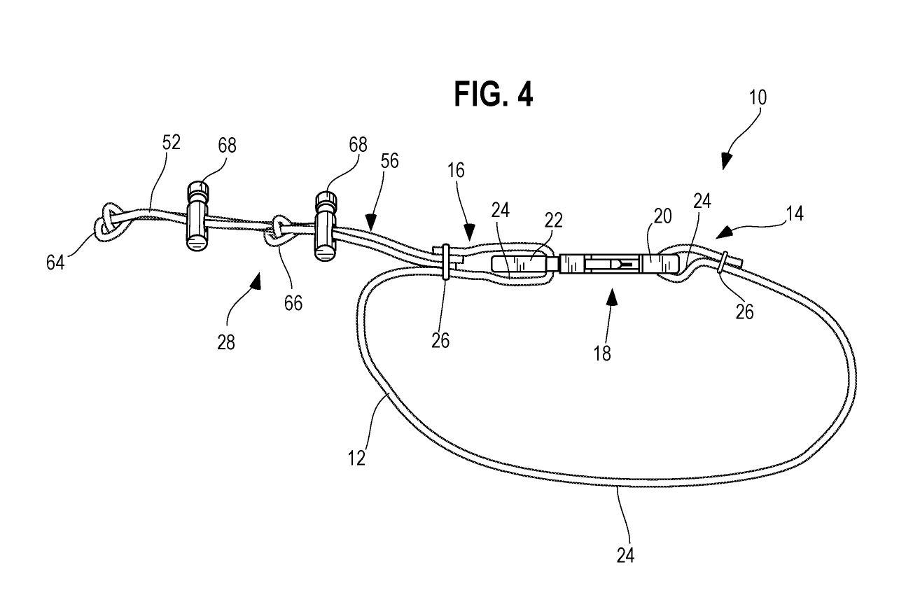

As best shown in FIG. 3, fastener 18 can include a conventional female buckle 20 secured to first end 14 of elongate strap 12 and a corresponding conventional male end buckle 22 secured to second end 16 of elongate strap 12. It is also recognized that the male end buckle 22 can be secured to first end 14 and the female end buckle 20 can be secured to second end 16 in a just as suitable alternative embodiment of the present invention. Conventional female end buckle 20 can be secured to first end 14 by threading first end 14 through a slot defined in buckle 20 and securing first end 14 to elongate strap 12 so that buckle 20 remains connected to first end 14 of strap 12. According to one embodiment, after looping first end 14 through the slot in buckle 20, it can be secured to the outer surface 24 of strap 14 by sewing a securement seam 26 through an overlapping region of first end 20 and outer surface 24 as best shown in FIG. 4. Alternatively, first end 14 can be secured to an inner surface region of strap 14 and/or secured by any other suitable means, including but not limited to adhesives, heat fusing, clamps, clips and the like. As also shown in FIG. 4, conventional male end buckle 22 can be similarly secured to second end 16 by threading second end 16 through a slot in buckle 22 and securing second end 16 to elongate strap 12 via outer surface 24 and securement seam 26 in a manner similar to buckle 20 and first end 14 described above. In addition, attached to elongate strap 12 can be a snare 28, as described in greater detail below, for holding items such as socks, gloves, cap, and similar items without openings.

Laundry holder 10 and elongate strap 12 can have any suitable length depending on the particular embodiment of the present invention, such as, but not limited to, a range approximately between fourteen inches (14″) and twenty-eight inches (28″). The holder 10 should preferably have a length long enough to allow elongate strap 12 to hold multiple garments when fastener 18 is connected in a manner that minimizes bunching of garments during washing and drying cycles. One improved feature of the present invention is the adaptation of an increased length of elongate strap 12, such as an approximate length between twenty-four and thirty-two inches (24-32″), allowing holder 10 to accommodate an increased number of garments typically laundered in facility or group environments.

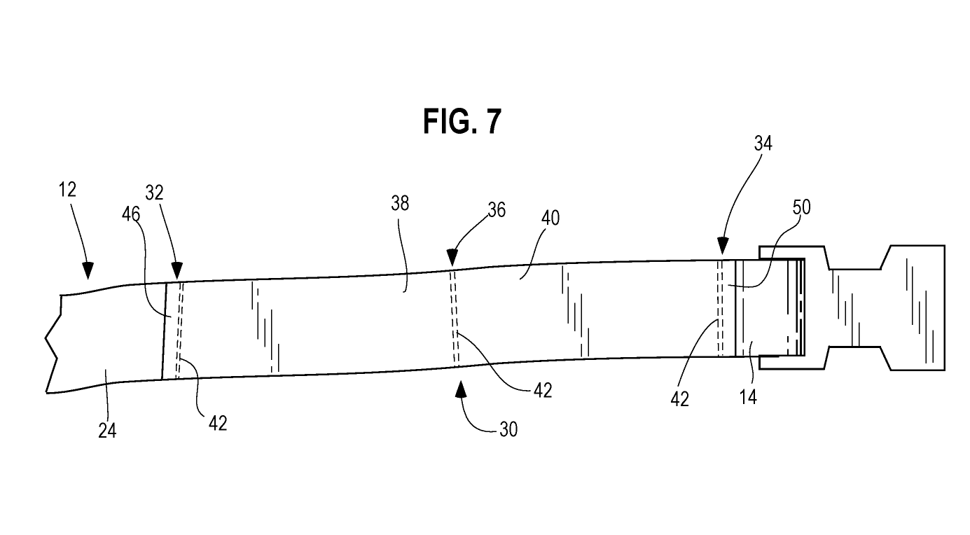

Elongate strap 12 can include an improved ID label 30, as best shown in FIGS. 1 and 7, allowing users of the laundry holder 10 to provide identification (names, number, etc.) on laundry holder 10. ID label 30 can include a first end 32, a second end 34, and a central divider region 36. Divider region 36 can allow placement of manufacturer information, company information or the like in a first region 38 and placement of user identification information in a second region 40. ID label 30 can be any number of different lengths, and in one embodiment, ID label 30 has a length of approximately four to five inches, allowing for more space for the user to place, write or update ID information.

According to one embodiment, as best shown in FIG. 7, second region 40 is positioned adjacent to fastener 18, such as placement by buckle 20 or 22 at first or second end 14 or 16. This improvement can facilitate locating the user ID information during handling of one or more laundry holders 10. Because users typically grab each laundry holder 10 by fastener 18, this improvement can eliminate the need to shift garments in order to expose ID information.

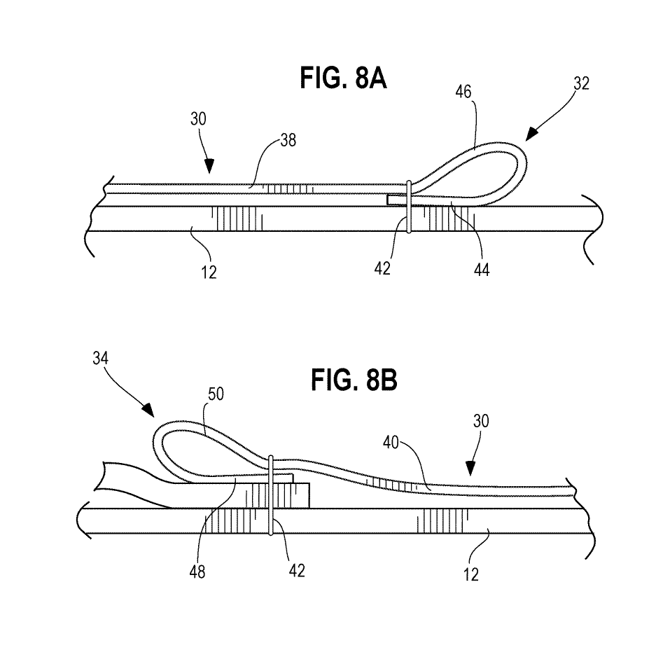

ID label 30 can be attached to elongate strap 12 by any number of suitable means depending on the particular embodiment of the present invention. According to an improved embodiment as illustrated in FIGS. 7, 8A and 8B, ID label 30 is attached to elongate strap 12 by sewing first end 32, second end 34 and central divider region 36 to elongate strap 12, preferably on outer surface region 24, to create a connecting seam 42 at each first end 32, second end 34 and divider region 36. Adhesives, clamps, clips and the like can also be used in alternative embodiments. Prior to securing first end 32 to strap 12, a portion of first end 32 can be folded inward forming a folded section 44 situated under a top section 46 as best shown in FIG. 8A. Similarly, second end 34 can be folded inward prior to attachment to strap 12 forming a folded section 48 situated beneath a top section 50 as best shown in FIG. 8B. One seam 42 can be sewn through both folded section 44 and top section 46 of first end 32 as well as strap 12 as best shown in FIG. 8A. Similarly, another seam 42 can be sewn through both folded section 48 and top section 50 of second end 34 as well as strap 12 as best shown in FIG. 8B. Accordingly, the folded sections 44 and 48 can remain situated beneath the top sections 46 and 50, respectively, after the label 30 is sewn or otherwise secured onto the strap 12, creating a folded end at the first and second ends 32 and 34 of label 30 as illustrated in FIG. 7.

Folding under folded sections 44 and 48 of ID label 30 prior to securing it to strap 12 can stabilize label 30 by reducing the chance of frayed edges and subsequent detachment of label 30 from strap 12 during use. As also shown in FIG. 7, ID label 30 can be further secured to strap 12 by sewing or otherwise attaching central divider region 36 to strap 12, such as by sewing a seam 42 connecting region 36 to strap 12. This can further minimize the chance for ID label 30 to be unintentionally ripped off, or otherwise separated from strap 12, by the user when laundry holder 10 is being removed from a washer or dryer. This can also eliminate the opportunity for garments to become snagged between elongated strap 12 and ID label 30. When garments become wedged in this manner, they are unable to wash and/or dry efficiently.

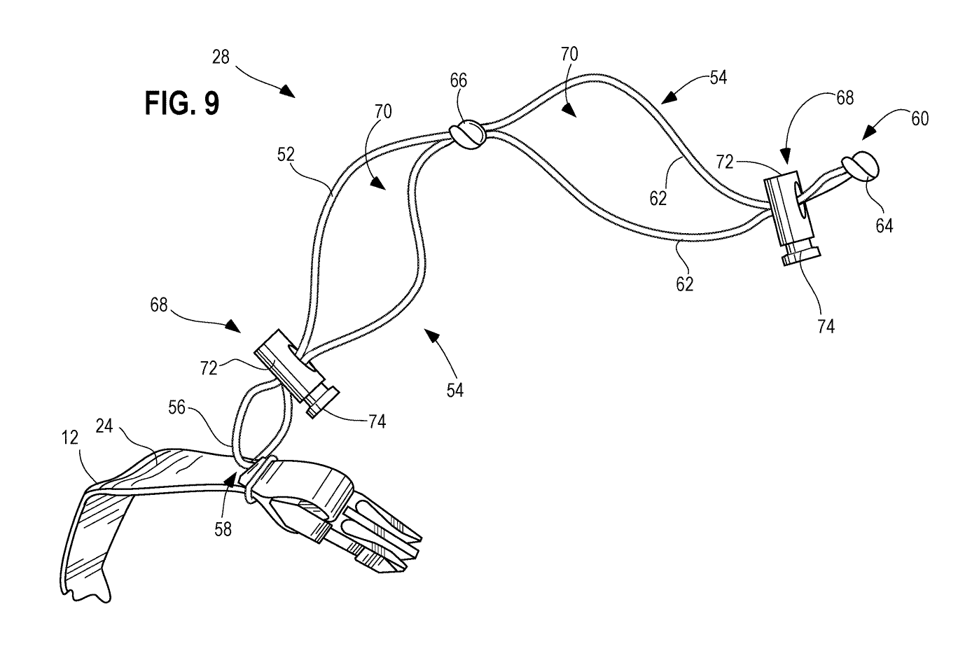

As described above, laundry holder 10 can include a garment snare 28 according to certain embodiments of the present invention as best shown in FIGS. 1 and 9. Garment snare 28 can comprise a length of cording 52 that can be separated into one or more loading regions 54. As shown in FIG. 3, snare 28 can have a single loading region 54 according to one embodiment of the present invention. As shown in FIG. 9, snare 28 can have two loading regions 54 according to one embodiment, illustrating an improvement over the prior art. Increasing the number of loading regions 54 permits a smaller volume of fabric to become “bunched together” when garments without openings are secured in snare 28, resulting in more efficient washing and drying of the garments. Garment snares 28 with more than two loading regions 54 are also considered within the scope of the present invention. Length of cording 52 can be any number of different lengths according to various embodiments of the present invention. Garment snare 28 can also be constructed as a clip, pin, clamp, or the like extending from and secured to elongated strap 12. Such a clip, pin, clamp or the like can include securing means (e.g., slots, notches, teeth, etc.) for securing socks, gloves and other garments to garment snare 28 and therefore laundry holder 10. For example, according to one embodiment of the present invention, garment snare 28 can comprise a jaw clamp or alligator clamp selectively securable between an opened and closed position. The jaw clamp can be any suitable type of jaw clamp, such as a serrated jaw clamp having one or more notches or teeth and can be constructed from plastic, metal or other suitable material. The jaw clamp can be secured to strap 12 and/or can be used in connection with cording 52 to form garment snare 28. The jaw clamps can be configured to open and close at one end to form loading regions 54 so as to allow a user to insert a garment or pair of garments into the opened end of the jaw clamp and then secure the jaw clamp shut so that the garment(s) remain attached to the jaw clamp.

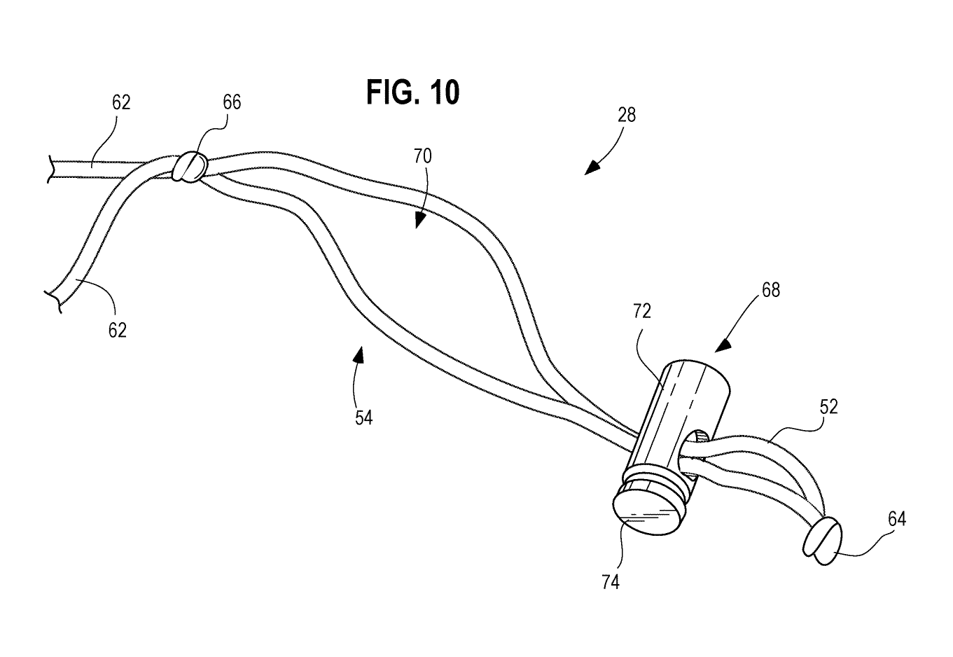

Cording 52 can include two tag ends 56 as shown in FIG. 9 which can be placed together forming a first end 58 secured to strap 12, and a second end 60 forming a closed loop of the cording 52 with two cording segments 62. Second end 60 of the loop of cording 52 can have an end stopper 64, as best shown in FIG. 10, such as half-hitch knot or other knot. Any other type of component, such as a clip, clamp, tie, zipper-pull, bead, posi-grip clamp or the like can also be used for end stopper 64. Additional intermediate stoppers 66 may be placed along the loop of cording 52 in order to form multiple loading regions 54, as best shown in FIG. 9. The figures illustration of stoppers 64 and 66 as knots are merely exemplary and it is recognized that or more stoppers 64 and 66 can be configured as any type of knot, zipper-pull, bead, posi-grip clamp or other suitable means of a stopper.

Within each loading region 54 can be a releasable cordlock fastener 68 for adjusting the size of an opening 70 within each loading region 54. The loop of cording 52 and each cord segment 62 can be threaded through each releasable cordlock fastener 68 prior to forming stoppers 64 and/or 66. Stoppers 64 and/or 66, in conjunction with first end 56, retain each fastener 68 on the loop of cording 62. In a preferred embodiment, each fastener 68 is a conventional cordlock 72 with a spring biased plunger 74 as illustrated in FIGS. 9 and 10. Fastener 68, including cordlock 72 and plunger 74, can be constructed from any suitable material, and according to one particular embodiment, can be constructed from an ACETAL material having advantageous water absorption characteristics to increase the durability of fastener 68 after several washing and drying cycles of laundry holder 10. When the plunger 74 is depressed, the cordlock 72 may be slidably moved along loop of cording 52, and when the button plunger 74 is released, the cordlock 72 is secured in its current position along loop of cording 52.

Cordlock 72 can also be constructed as any other suitable type of cinching means in various embodiment of the present invention. For example, cordlock 72 can be constructed as a clip, clamp, tie, zipper-pull, posi-grip clamp or the like. According to one embodiment, cordlock 72 can comprise a removable or non-removable and/or slidable clip having slots, notches or teeth configured to secure cording 52 together.

First end 56 of cording 52 can be attached to elongate strap 12 as best shown in FIG. 9. According to one embodiment, first end 56 is attached to outer surface 24 of strap 12 by sewing or other suitable means. Attaching to outer surface 24 as opposed to the inner surface of strap 12 can reduce entanglement of clothing items carried by strap 12 with items carried by snare 28 and items from other laundry holders 10. Traditional laundry holders known in the prior art have a snare attached on the interior of the elongate strap. As a result, the snare would commonly tangle with garments held by the laundry holder, especially if the snare was too long. According to the present invention, garment snare 28 can have a length of cording 52 any number of different lengths, including extended lengths suitable for two or more loading regions 54 due to the method of attaching snare 28 to strap 12.

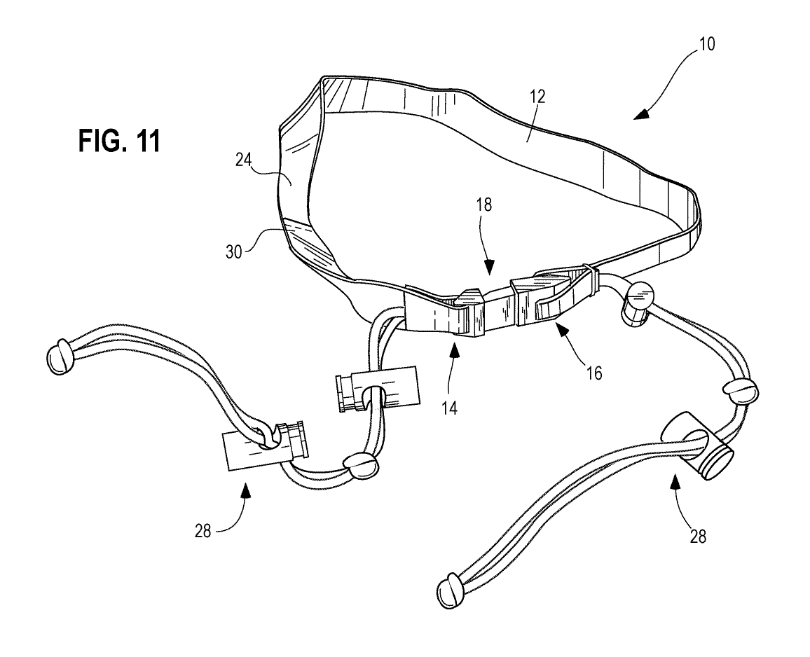

According to one embodiment of the present invention, laundry holder 10 can include additional snares 28 as best shown in FIG. 11. The second snare 28 can be constructed in a manner similar to first snare 28 and connected to first or second end 14 or 16 of strap 12 opposing first snare 28. The additional snare 28 can enable a user to launder an increased number of socks, gloves, caps and other similar items without an opening, at the same time.

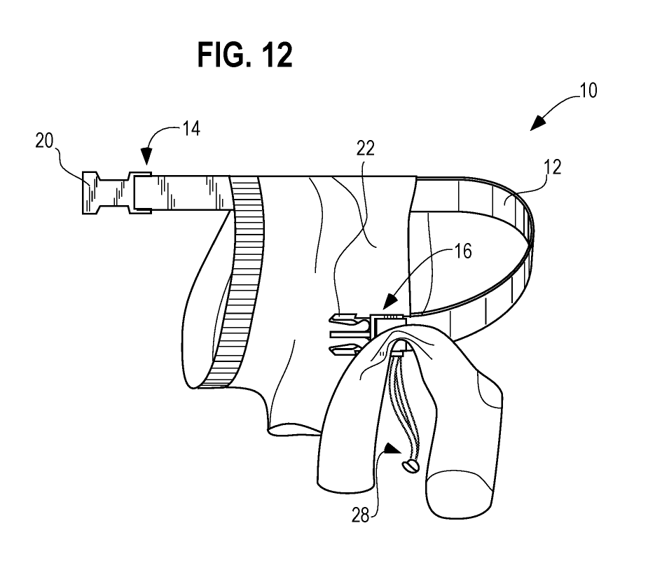

To operate the laundry holder 10, one end 14 or 16 of strap 12 is led through the openings of one or more items of clothing as illustrated in FIG. 12. The fastener 18 can then be secured by connecting buckle ends 20 and 22. Snare 28 can then be loaded by inserting clothing items, such as a pair of socks, into the opening 70 of a loading region 54 and sliding fastener 68 along cording 52 until the clothing item is snugly secured within the loading region 54.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A laundry holder comprising:
an elongated strap having a first end, a second end and fastening means connected to each of said first and said second ends for allowing said first and said second ends to be secured together so that said elongated strap is selectively configurable into an enclosed loop;
an ID label attached to said elongated strap, said ID label including a first folded end and a second folded end, wherein each of said folded ends are secured to said elongated strap; and
a garment snare attached to said elongated strap.

2. The laundry holder of claim 1 wherein each of said first and said second folded ends comprises a lower folded portion and an upper folded portion, wherein said lower folded portion is positioned against said elongated strap and said upper folded portion is positioned against said lower folded portion opposite said elongated strap.

3. The laundry holder of claim 2 wherein said each of said first and said second folded ends are secured to said elongated strap by a securement seam extending through said upper folded portion, said lower folded portion and said elongated strap.

4. The laundry holder of claim 1 wherein said ID label includes a first region adjacent to said first folded end and a second region adjacent to said second folded end, wherein said first and said second regions are separated by a central dividing region.

5. The laundry holder of claim 4 wherein said central diving region is secured to said elongated strap by a securing seam.

6. The laundry holder of claim 4 wherein said ID label is attached to said elongated strap so that said second end of said ID label is adjacent to one of said first and said second ends of said elongated strap.

7. The laundry holder of claim 6 wherein said second end of said ID label is configured for holding a set of user information.

8. The laundry holder of claim 1 wherein said ID label is secured to an outer surface of said elongated strap.

9. The laundry holder of claim 1 wherein said fastening means comprises a releasable buckle including a first buckle component connected to said first end of said elongated strap and a second buckle component connected to said second end of said elongated strap, wherein said first and said second buckle components comprise an acetal material.

10. The laundry holder of claim 1, wherein said garment snare comprises at least one of a length of cording and a jaw clamp.

11. The laundry holder of claim 1 wherein said garment snare has a first cord section and a second cord section and a securement component for securing one or more garments between said first and said second cord sections, and wherein said garment snare is attached to said elongated strap at a location adjacent to said first end of said elongated strap and said ID label is attached to said elongated strap at a location adjacent to said second end of said elongated strap.

12. The laundry holder of claim 1 further comprising a second garment snare attached to said elongated strap, said second garment snare having a first cord section and a second cord section and a securement component for securing one or more garments between said first and said second cord sections.

13. A laundry holder comprising:
an elongated strap having a first end and a second end, wherein each of said first and said second ends has a fastening component configured thereon for allowing said elongated strap to be selectively configured into an enclosed loop; and
a first garment snare comprising:
a cording having a first end and a second end, said cording including a first cord segment and a second cord segment;
an end stopper positioned at said second end of said cording;
at least one intermediate stopper positioned between said first end and said second end of said cording;
a first loading region extending through an opening between said first and said second cord segments and defined between said first end of said cording and said at least one intermediate stopper;
a second loading region extending through an opening between said first and said second cord segments and defined between said at least one intermediate stopper and said second end of said cording; and
a cordlock fastener positioned in each of said first and said second loading regions;
wherein said first and said second loading regions and said cordlock fasteners are configured for receiving and retaining one or more garments.

14. The laundry holder of claim 13 wherein said cordlock fastener includes an opening for receiving first and said second cord segments so that said cord segments can be threaded through said cordlock fastener and retain said cordlock fastener in said first or second loading region, and wherein said cordlock fastener is selectively moveable along a length of said first or said second loading region.

15. The laundry holder of claim 13 wherein at least one of said intermediate stoppers and said end stoppers comprises one of a knot formed from said cording, a zipper-pull, a bead, a clip and a posi-grip clamp.

16. The laundry holder of claim 13 wherein said cordlock fastener comprises a cordlock and a spring biased plunger partially inserted into said cordlock.

17. The laundry holder of claim 13 further comprising an ID label attached to said elongated strap, said ID label including a first folded end and a second folded end, wherein each of said folded ends are secured to said elongated strap.

18. The laundry holder of claim 17 wherein each of said first and said second folded ends comprises a lower folded portion and an upper folded portion, wherein said lower folded portion is positioned against said elongated strap and said upper folded portion is positioned against said lower folded portion opposite said elongated strap;

19. The laundry holder of claim 18 wherein said each of said first and said second folded ends are secured to said elongated strap by a securement seam extending through said upper folded portion, said lower folded portion and said elongated strap.

20. The laundry holder of claim 13 further comprising a second garment snare comprising:
a cording having a first end and a second end, said cording including a first cord segment and a second cord segment;
an end stopper positioned at said second end of said cording;
at least one intermediate stopper positioned between said first end and said second end of said cording;
a first loading region extending through an opening between said first and said second cord segments and defined between said first end of said cording and said at least one intermediate stopper;
a second loading region extending through an opening between said first and said second cord segments and defined between said at least one intermediate stopper and said second end of said cording; and
a cordlock fastener positioned in each of said first and said second loading regions.
